(19) United States
(12) Patent Application Publication
(10) Pub. No.: US 2003/0098194 A1
(43) Pub. Date: May 29, 2003

(54) Ingnition control for automatic safety belts

(76) Inventor: Ethyl Roddy, Arlington, TX (US)

Correspondence Address: Howard N. Flaxman, WELSH & FLAXMAN LLC, Suite 112, 2341 Jefferson Davis Hwy., Arlington, VA, 22202, US

(21) Appl. No.: 09/994,762

(22) Filed: Nov. 28, 2001

(51) Int. Cl. B60R 21/00

(52) U.S. Cl. 180/270; 180/268

(57) ABSTRACT

A seatbelt safety system for an automobile including at least one seat having a seatbelt associated therewith. The seatbelt safety system includes at least one seat sensor identifying when a passenger is seated within the vehicle seat, at least one seatbelt sensor identifying whether a passenger identified by the seat sensor has fastened the seatbelt of the seat and an automobile state sensor identifying when the automobile is operating in a predetermined manner. The safety system further includes a control system lined to the seat sensor, the seatbelt sensor and the automobile state sensor. The control system includes circuitry for preventing one from starting a vehicle engine when the seat sensor and seatbelt sensor indicate that a passenger is seated within the seat without a fastened seatbelt. The control system further includes a mechanism for locking the seatbelt when the automobile state sensor indicates to the control system that the automobile is operating in a predetermined manner.

### BACKGROUND OF INVENTION

1. Field of the Invention

The invention relates to a seatbelt safety system directly linked to the ignition of an automobile. More particularly, the invention relates a seatbelt safety system which prevents both the starting of the engine when all seatbelts are not fastened and the unfastening of seatbelts once the engine has been started.

2. Description of the Prior Art

The art relating to seatbelt fastening systems is highly developed and a variety of techniques have been developed for warning passengers that they are not properly secured within their respective seats. However, these prior techniques focus on warning passengers that their seatbelts are not properly fastened or prevent use of the automobile when the seatbelts are not properly fastened.

With this in mind, the prior art has yet to address the problems associated with passengers, particularly, small children, unfastening their seatbelts once the automobile has been started and begun moving. Once the automobile has been started and has begun moving, there is little a parent can do to prevent their small child from unfastening a previously fastened seatbelt. As such, a need exists for a system by which passengers may be prevented from unfastening their seatbelts once the automobile has begun operating. The present invention provides such a system.

### SUMMARY OF THE INVENTION

It is, therefore, an object of the present invention to provide a seatbelt safety system for an automobile including at least one seat having a seatbelt associated therewith. The seatbelt safety system includes at least one seat sensor identifying when a passenger is seated within the vehicle seat, at least one seatbelt sensor identifying whether a passenger identified by the seat sensor has fastened the seatbelt of the seat and an automobile state sensor identifying when the automobile is operating in a predetermined manner. The safety system further includes a control system linked to the seat sensor, the seatbelt sensor and the automobile state sensor. The control system includes circuitry for preventing one from starting a vehicle engine when the seat sensor and seatbelt sensor indicate that a passenger is seated within the seat without a fastened seatbelt The control system further includes a mechanism for locking the seatbelt when the automobile state sensor indicates to the control system that the automobile is operating in a predetermined manner.

It is also an object of the present invention to provide a seatbelt safety system wherein a plurality of seats are provided and a seat sensor and a seatbelt sensor are respectively provided with each of the plurality of seats.

It is another object of the present invention to provide a seatbelt safety system wherein the control system includes a control processor.

It is a further object of the present invention to provide a seatbelt safety system wherein the mechanism for locking include a security lock associated with a seatbelt latching mechanism for locking the seatbelt latch mechanism in a locked status upon receipt of an indication the automobile is operating in a predetermined manner.

It is still another object of the present invention to provide a seatbelt safety system wherein the mechanism for locking prevents unlatching of the seatbelt latch mechanism when the automobile has been shifted out of Park.

It is yet a further object of the present invention to provide a seatbelt safety system wherein a bypass is associated with the control system for overriding the control system when the seat sensor and seatbelt sensor indicate that a passenger is seated within the seat without a fastened seatbelt and the control system would otherwise prevent ignition of the automobile.

It is also another object of the present invention to provide a seatbelt safety system wherein a warning is issued when the bypass overrides the control system and a seatbelt is unfastened.

It is a further object of the present invention to provide a seatbelt safety system wherein a bypass is associated with the control system for overriding the control system when the automobile state sensor indicates to the controller that the automobile is operating in a predetermined manner and the mechanism for locking would otherwise lock the seatbelt latch mechanism.

It is still a further object of the present invention to provide a seatbelt safety system wherein the control system includes a seat switch which is opened upon sensing an individual sitting within the seat to thereby prevent the flow of electrical charge to the automobile ignition.

It is another object of the present invention to provide a seatbelt safety system wherein the control system includes a seatbelt switch which is closed only upon sensing that an individual sitting within the seat of an automobile has fastened the seatbelt.

It is also an object of the present invention to provide an automobile including a seatbelt safety system as described above.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic for a control system in accordance with the present invention

FIG. 2 is a cross sectional view of a latching mechanism used in accordance with a preferred embodiment of the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for the claims and as a basis for teaching one skilled in the art how to make and/or use the invention.

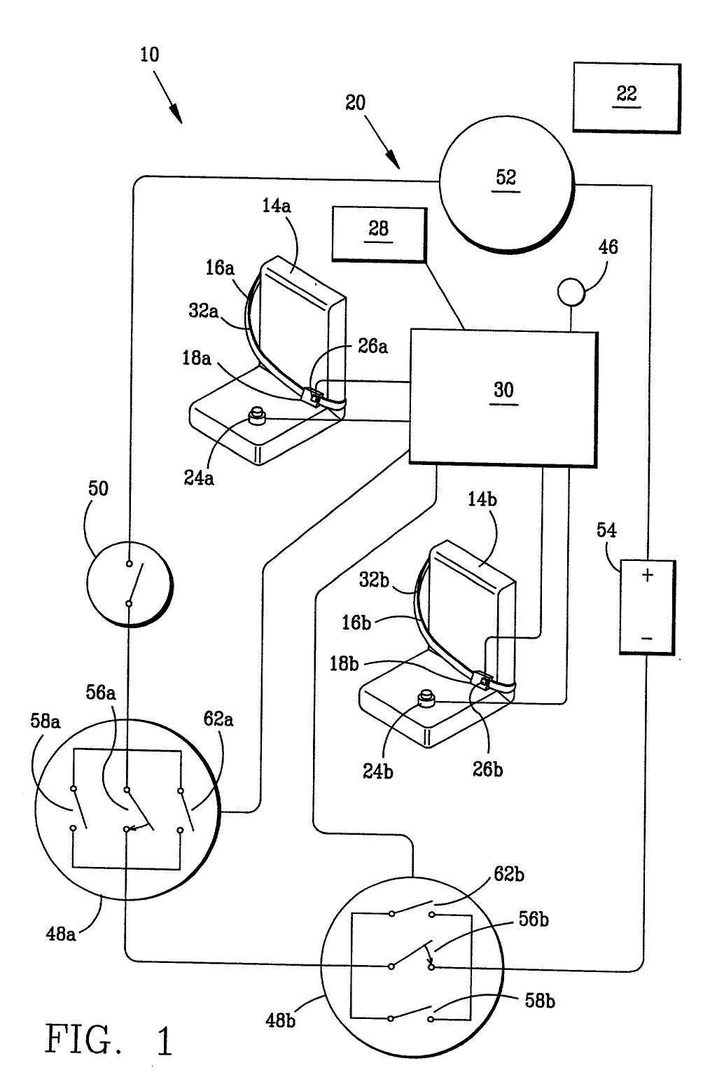

With reference to FIG. 1, a seatbelt safety system 10 for an automobile 12 is disclosed. In accordance with a preferred embodiment of the present invention, the seatbelt safety system 10 is adapted for use in conjunction with a traditional automobile 12 including a plurality of seats 14a, 14b, each of which includes a seatbelt 16a, 16b having a locking latch mechanism 18a, 18b associated therewith. The automobile 12 in accordance with the present invention will also include an electronic ignition system 20 linked to the automobile engine 22. While the present invention is described below for use in conjunction with a traditional internal combustion automobile, it should be understood that the underlying concepts of the present invention may be applied to various automobile types, for example, electric automobiles, without departing from the spirit of the present invention.

Briefly, the seatbelt safety system 10 includes a seat sensor 24a, 24b associated with each of the automobile seats 14a, 14b. The seat sensor 24a, 24b identifies when a passenger is seated within the automobile seat 14a, 14b. The seatbelt safety system 10 also includes a seatbelt sensor 26a, 26b associated with each of the automobile seats 14a, 14b. The seatbelt sensor 26a, 26b identifies whether a passenger identified by the seat sensor 24a, 24b has fastened the seatbelt 16a, 16b of the seat 14a, 14b. The seatbelt safety system 10 further includes an automobile state sensor 28 associated with the automobile engine 22. The automobile state sensor 28 identifies when the automobile 12 is operating in a predetermine manner.

The seatbelt safety system 10 further includes a control system 29, including a control processor 30, linked to the seat sensor 24a, 24b, the seatbelt sensor 26a, 26b and the automobile state sensor 28. The control system 29 includes a mechanism for preventing one from starting an automobile engine 22 when the seat sensor 24a, 24b and seatbelt sensor 26a, 26b indicate that a passenger is seated within the seat 14a, 14b without a fastened seatbelt 16a, 16b and the control system 29 further includes a mechanism for locking the seatbelt 16a, 16b when the automobile state sensor 28 indicates to the control processor 30 that the automobile 12 is operating in a predetermined manner.

With regard to the automobile seat sensor 24a, 24b, a pressure sensitive seat sensor 24a, 24b is positioned within each seat 14a, 14b. Each of these seat sensors 24a, 24b monitor pressure applied to the automobile seat 14a, 14b in an effort to ascertain whether a passenger is seated within the automobile seat 14a, 14b. Sensors such as these are well known in the prior art and specific types of sensors may be used in conjunction with the present invention without departing from the spirit thereof.

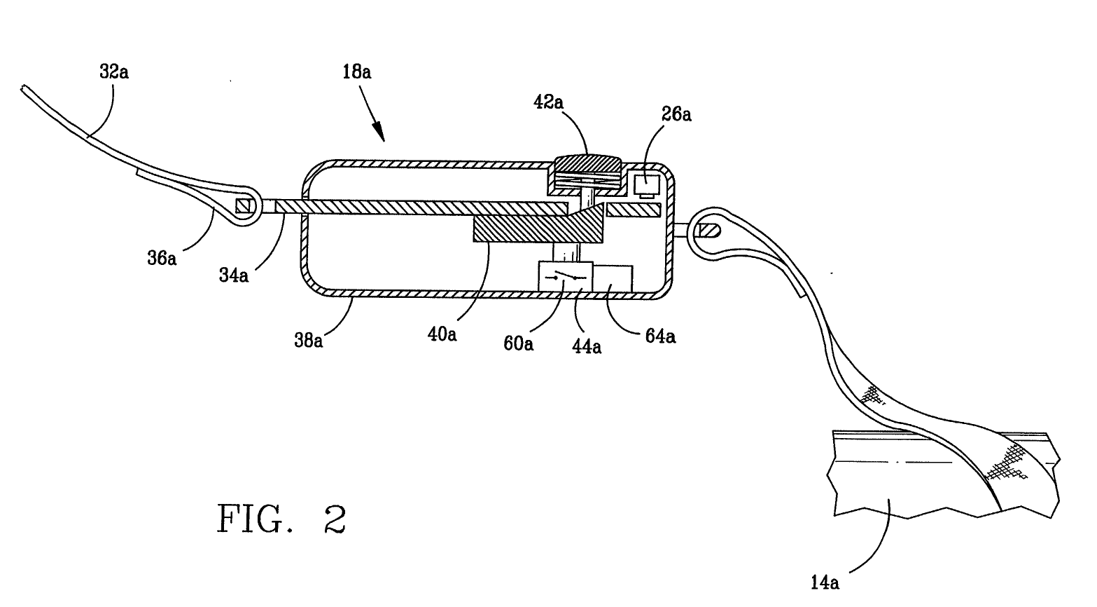

With regard to the seatbelt sensor 26a, 26b, and in accordance with a preferred embodiment of the present invention, an electronic sensor 26a, 26b is positioned within the latch mechanism 18a, 18b of the seatbelt 16a, 16b. More specifically, the seatbelt 16a, 16b in accordance with the present invention includes a restraining strap 32a, 32b and a latch mechanism 18a, 18b. The latch mechanism (see FIG. 2 which shows the first latch member in detail; the second latch mechanism is identical) 18a, 18b includes a male member, or tongue plate, 34a secured to a distal end 36a of the restraining strap 32a and a female member, or buckle, 38a securely attached to the automobile 10 adjacent the seat 14a with which the seatbelt 16a is associated. As with conventional seatbelts known to those skilled in the art, the restraining strap 32a is selectively withdrawn such that one may insert the male member 34a at the distal end 36a of the restraining strap 32a within the female member 38a securely attached to the automobile 10. Once the male member 34a is inserted within the female member 38a, a locking element 40a within the female member 38a engages the male member 34a to securely and selectively hold the male and female members 34a, 38a in a locked relationship until such a time that a release button 42a is pressed. While a specific latch mechanism is disclosed in accordance with a preferred embodiment of the present invention, those skilled in the art are certainly familiar with a variety of latch mechanism which may be employed without departing from the spirit of the present invention.

As those skilled in the art will certainly appreciate, electronic sensors used to monitor proper latching of male and female members within a seatbelt latching mechanism are know to those skilled in the art, and any of these known sensor may be used in accordance with the present invention. It is only required that the sensor detect proper latching of the male and female members, and transmit a signal indicating proper latching to the control system 29 employed in accordance with the present invention.

In addition to the seatbelt sensor 26a, 26b discussed above, the latch mechanism 18a, 18b is further provided with a security lock 44a associated with the locking element 40a discussed above. As will be discussed below in greater detail, the security lock 44a interacts with the locking element 40a to prevent unlocking of the male and female members 34a, 38a while the automobile is operating, or until such a time that the driver, or other designated individual, determines that it is acceptable to release the locked male and female members 34a, 38b. This release system is integrated with a warning light 46 (other warning devices, for example, audible signals may also be used), which will be actuated when a seatbelt 16a, 16b is unfastened and will continue until such a time that the seatbelt 16a, 16b is refastened.

The control system 29, and particularly, the control processor 30, links all of the seatbelt safety system components, that is, the seat sensors 24a, 24b, the seatbelt sensors 26a, 26b and the automobile state sensor 28 to provide enhanced safety for those riding within the automobile 10. The control processor 30 processes information from the various components to function in the following manner

Preventing one from starting an automobile engine when any of the seat sensors 24a, 24b and seatbelt sensors 26a, 26b indicate that a passenger is seated within the seat 14a, 14b without a fastened seatbelt 16a, 16b.

Locking the latch mechanism 18a, 18b of the seatbelt 16a, 16b when the automobile state sensor 28 indicates to the control processor 30 that the automobile 10 is operating in a predetermined manner.

Facilitating release of the latch mechanism 18a, 18b upon an indication by the driver, or other designated individual, that it is safe to release the seatbelt latch mechanism 18a, 18b.

Facilitating release of the latch mechanism 18a, 18b upon sensing that an accident has occurred, for example, air bags deployed, shutdown of the engine, etc., and it is necessary to release the seatbelt latch mechanism 18a, 18b for the safety of the automobile occupants.

A schematic of a safety system 10 in accordance with a preferred embodiment of the present invention is disclosed. The safety system 10 is disclosed in conjunction with only two seats 14a, 14b, however, those skilled in the art will appreciate the fact that any number of seats commonly found in an automobile may be incorporated within the system. In accordance with a preferred embodiment for a two seat automobile 12, the control system 29 is provided with first and second seat modules 48a, 48b linked in series with the automobile ignition system 20, that is, the ignition switch 50, ignition coil 52 and battery 54. Each module 48a, 48b is assigned to a specific seat 14a, 14b and is linked to the seat sensor 24a, 24b and a seatbelt sensor 26a, 26b for the specific seat 14a, 14b.

In accordance with the preferred embodiment disclosed with reference to FIG. 1, the first seat 14a includes a first seat sensor 24a linked to a first seat switch 56a within the first seat module 48a and a first seatbelt sensor 26a linked to a first seatbelt switch 58a within the first seat module 48a. Similarly, the second seat 14b includes a second seat sensor 24b linked to a second seat switch 56b within the second seat module 48b and a second seatbelt sensor 26b linked to a second seatbelt switch 58b within the second seat module 48b.

With reference to either the first or second seat switch 56a, 56b, it is normally closed and switches to an open position upon an indication that a passenger is sitting within the seat 14a, 14b. In contrast, the first and second seatbelt switches 58a, 58b are normally open and are switched to a closed position upon receiving and indications that the seatbelt 16a, 16b has been properly latched to restrain the passenger within the seat 14a, 14b.

As mentioned above, the control system 10 is linked in series with the vehicle ignition system 20 and prevents the flow of electrical power to the ignition coil 52, and ultimately starting of the automobile 12, when any seat module 48a, 48b of the control system 10 includes both an open seat switch 56a, 56b and an open seatbelt switch 58a, 58b. That is, the flow of electrical power to the ignition coil 52 is prevented when the seat sensor 24a, 24b indicates a passenger is within the seat 14a, 14b, but the seatbelt sensor 26a, 26b indicates that the seatbelt 16a, 16b associated with the seat has not been fastened.

The control system 10 further includes an automobile state sensor 28 linked to the engine 22 of the automobile 12 for monitoring the operating condition of the automobile 12. The automobile state sensor 28 is linked to the control processor 30 which determines when the security lock 44a associated with each seat 14a, 14b is to be switched to its locked status, thereby, preventing passengers from unfastening a seatbelt 16a, 16b.

In accordance with a preferred embodiment of the present invention, the control processor 30 actuates the switch 60a of the security lock 44a to a locked status upon receiving an indication from the automobile state sensor 28 that the automobile has been shifted out of “Park”. While the seatbelt security locks 44a are actuated upon shifting the automobile 12 out of “Park” in accordance with a preferred embodiment of the present invention, other criteria may be established for the control of the security locks 44a without departing from the spirit of the present invention.

In accordance with a preferred embodiment of the present invention, the security locks 44a are generally an electromechanical locking structure that interferes with the standard latch mechanism to prevent disengagement of the male and female members 34a, 38a thereof. As such, a variety of structures may be utilized within the spirit of the present invention.

In an effort to provide for enhanced convenience and safety, both the first and second seat modules 48a, 48b within the ignition circuit 20 of the present control system 10 and the security locks 44a of the present control system 10 are provided with bypass switches 62a, 62b, 64a allowing a driver, or other designated individual, to override controls issued by the control system 29. With regard to the first and second seat modules 48a, 48b, the respective bypass switches 62a, 62b provided therein enable one to close the circuit despite an indication that a passenger is seated within the seat 14a, 14b and has not properly fastened the seatbelt 16a, 16b.

Similarly, the security lock 44a is provided with a bypass switch 64a which permits one to override the security lock 44a and allow a passenger to unfasten a seatbelt 16a, 16b despite an indication that the automobile 12 is operating in a predetermined manner, for example, the vehicle has been shifted out of “Park”. In addition to the actuation of the security lock bypass switch 64a via a user interface, the bypass switch will be actuated upon sensing that an accident or other emergency has occurred, for example, air bags deployed, shutdown of the engine, etc., and it is necessary to release the seatbelt latch mechanism for the safety of the automobile occupants.

Both the security lock bypass switch 64a and the seat module bypass switches 62a, 62b are electrically linked to a user interface (not shown) freely accessible to the individual provided with control over the present system 10. As such, a variety of circuitry, processors and switches may be employed without departing from the spirit of the present invention. It should further be appreciated that although the bypass switches 62a, 62b, 64a may be used to permit unfastening of seatbelts 16a, 16b during and/or prior to operation of an automobile in accordance with the present invention, the warning light 46 discussed above will be actuated upon identification of an unfastened seatbelt 16a, 16b while the bypass switches 62a, 62b, 64a are operating (or closed). The warning light 46 will continue in operation until such a time that the unfastened seatbelts 16a, 16b are properly fastened.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A seatbelt safety system for an automobile including at least one seat having a seatbelt associated therewith, the seatbelt safety system comprising:
at least one seat sensor identifying when a passenger is seated within the vehicle seat;
at least one seatbelt sensor identifying whether a passenger identified by the seat sensor has fastened the seatbelt of the seat;
an automobile state sensor identifying when the automobile is operating in a predetermined manner,
a control system linked to the seat sensor, the seatbelt sensor and the automobile state sensor, the control system including means for preventing one from starting a vehicle engine when the seat sensor and seatbelt sensor indicate that a passenger is seated within the seat without a fastened seatbelt and the control system further including means for locking the seatbelt when the automobile state sensor indicates to the control system that the automobile is operating in a predetermined manner.

2. The seatbelt safety system according to claim 1, wherein a plurality of seats are provided and a seat sensor and a seatbelt sensor are respectively provided with each of the plurality of seats.

3. The seatbelt safety system according to claim 1, wherein the control system includes a control processor.

4. The seatbelt safety system according to claim 1, wherein the means for locking include a security lock associated with a seatbelt latching mechanism for locking the seatbelt latch mechanism in a locked status upon receipt of an indication the automobile is operating in a predetermined manner.

5. The seatbelt safety system according to claim 4, wherein the means for locking prevents unlatching of the seatbelt latch mechanism when the automobile has been shifted out of Park.

6. The seatbelt safety system according to claim 1, wherein a bypass is associated with the control system for overriding the control system when the seat sensor and seatbelt sensor indicate that a passenger is seated within the seat without a fastened seatbelt and the control system would otherwise prevent ignition of the automobile.

7. The seatbelt safety system according to claim 6, wherein a warning is issued when the bypass overrides the control system and a seatbelt is unfastened.

8. The seatbelt safety system according to claim 1, wherein a bypass is associated with the control system for overriding the control system when the automobile state sensor indicates to the controller that the automobile is operating in a predetermined manner and the means for locking would otherwise lock the seatbelt latch mechanism.

9. The seatbelt safety system according to claim 8, wherein a warning is issued when the bypass overrides the control system and a seatbelt is unfastened.

10. The seatbelt safety system according to claim 1, wherein the control system includes a seat switch which is opened upon sensing an individual sitting within the seat to thereby prevent the flow of electrical charge to the automobile ignition.

11. The seatbelt safety system according to claim 1, wherein the control system includes a seatbelt switch which is closed only upon sensing that an individual sitting within the seat of an automobile has fastened the seatbelt.

12. A automobile including a seatbelt safety system, comprising:
an automobile body having an engine with an ignition system and at least one seat having a seatbelt associated therewith;
the seat belt including a restraining strap and a locking mechanism for securing the restraining strap across the body of a passenger seated within the seat, wherein the locking mechanism includes means for preventing unlocking of the locking mechanism under predetermined conditions;
a seatbelt safety including
at least one seat sensor associated with the seat, the seat sensor identifying when a passenger is seated within the seat;
at least one seatbelt sensor associated with the seatbelt, the seatbelt sensor identifying whether a passenger identified by the seat sensor has fastened the seatbelt of the seat;
an automobile state sensor associated with the engine, the automobile state sensor identifying when the automobile is operating in a predetermine manner,
a control system linked to the seat sensor, the seatbelt sensor and the automobile state sensor, the control system including means for preventing one from starting the engine when the seat sensor and seatbelt sensor indicate that a passenger is seated within the seat without a fastened seatbelt and the controller further including means for locking the seatbelt when the automobile state sensor indicates to the control system that the automobile is operating in a predetermined manner.

13. The automobile according to claim 12, wherein a plurality of seats are provided and a seat sensor and a seatbelt sensor are respectively provided with each of the plurality of seats.

14. The automobile according to claim 12, wherein the control system includes a control processor.

15. The automobile according to claim 12, wherein the means for locking includes a security lock associated with a seatbelt latching mechanism for locking the seatbelt latch mechanism in a locked status upon receipt of an indication the automobile is operating in a predetermined manner.

16. The automobile according to claim 15, wherein the means for locking prevents unlatching of the seatbelt latch mechanism when the automobile has been shifted out of Park.

17. The automobile according to claim 12, wherein a bypass is associated with the control system for overriding the control system when the seat sensor and seatbelt sensor indicate that a passenger is seated within the seat without a fastened seatbelt and the control system would otherwise prevent ignition of the automobile.

18. The automobile according to claim 12, wherein a bypass is associated with the control system for overriding the control system when the automobile state sensor indicates to the controller that the automobile is operating in a predetermined manner and the means for locking would otherwise lock the seatbelt latch mechanism.

19. The automobile according to claim 12, wherein the control system includes a seat switch which is opened upon sensing an individual sitting within the seat to thereby prevent the flow of electrical charge to the automobile ignition.

20. The automobile according to claim 12, wherein the control system includes a seatbelt switch which is closed only upon sensing that an individual sitting within the seat of an automobile has fastened the seatbelt.
